(19) United States
(12) Patent Application Publication
(10) Pub. No.: US 2003/0197598 A1
(43) Pub. Date: Oct. 23, 2003

(54) Contactless IC card

(75) Inventor: Jouji Hayashi, Osaka (JP)

Correspondence Address: Jack Q. Lever, Jr., McDERMOTT, WILL & EMERY, 600 Thirteenth Street, N.W., Washington, DC, 20005-3096, US

(73) Assignee: Matsushita Electric Industrial Co., Ltd.

(21) Appl. No.: 10/334,774

(22) Filed: Jan. 2, 2003

(30) Foreign Application Priority Data
Apr. 4, 2002 (JP) 2002-102493

(51) Int. Cl. H04M 11/04

(52) U.S. Cl. 340/310.07

(57) ABSTRACT

A contactless IC card, to which power is externally supplied in a contactless manner, includes a shunt regulator and a demodulation circuit. The shunt regulator attenuates, in the supplied power, a signal component in a band unwanted for demodulating an RX signal. The demodulation circuit demodulates the RX signal from the power in which the signal component in the unwanted band has been attenuated by the regulator.

### BACKGROUND OF THE INVENTION

The present invention relates to a contactless IC card to which power is externally supplied in a contactless manner, and more particularly, it relates to a technique to suppress degradation of communication quality derived from device variation and temperature change.

An IC card including a CPU characterized by a security function and a personal identifier function is roughly classified into “an IC card with an external terminal (i.e., a contact IC card” that performs data communications with a reader/writer via a contact and “a contactless IC card” that performs the data communications through electromagnetic induction and the like. Between these IC cards, the contactless IC card that performs the data communications in a wireless manner does not need a terminal for contact with external equipment, and hence is good at durability. Furthermore, the contactless IC card does not need a battery because DC power necessary for the operation of the IC is generated by rectifying received radio waves with a rectifier, and therefore, it is effective in downsizing and reducing cost of a system using the IC card.

FIG. 9 is a diagram for showing the structure of a conventional contactless IC card. The contactless IC card 1 of FIG. 9 includes an antenna coil L1 and a semiconductor integrated circuit 2. The semiconductor integrated circuit 2 includes a tuning capacitor Ct, a charging capacitor Ca, a rectifier 3, a shunt regulator 4, a demodulator 6, a digital signal processor 7 and a modulator 8. The tuning capacitor Ct and the antenna coil L1 are connected to each other in parallel to be connected to the input of the rectifier 3. As the rectifier 3, a full-wave rectifying circuit including diodes D1 through D4 as shown in FIG. 10 is used. A signal received by the antenna coil L1 is rectified by the rectifier 3 and the resultant is charged in the charging capacitor Ca, so as to generate power VDD for the digital signal processor 7. The demodulator 6 extracts an RX signal (receiving signal) superimposed on the power VDD. The RX signal is processed by the digital signal processor 7 including a CPU, a memory and the like. The modulator 8 modulates impedance between the ends of the antenna coil in accordance with a TX signal (sending signal) sent from the digital signal processor 7. The shunt regulator 4 is a circuit for preventing the power VDD from increasing beyond the breakdown voltage of the semiconductor integrated circuit 2.

When it is herein assumed that ISO/IEC 14443 Type-B is employed as the communication method, the carrier frequency is 13.56 MHz, the transfer rate is 106 kbps, the modulation method from a reader/writer to the contactless IC card is 10% ASK modulation and the modulation method from the contactless IC card to a reader/writer is BPSK. In this case, the demodulator 6 extracts an RX signal by sensing variation in the amplitude of the power VDD.

Power supplied to a contactless IC card depends upon the magnetic field intensity applied to a card coil (i.e., the antenna coil L1). The magnetic field intensity is substantially constant when the distance between coils is small with respect to the size of the antenna coil of a reader/writer but is attenuated in inverse proportion to the square of the distance when the distance is large. In general, the distance between a contactless IC card and a reader/writer is changed more largely than the size of the antenna coil, and therefore, the power supplied to the IC card is largely varied. For example, it is assumed that the power VDD for the semiconductor integrated circuit 2 is 3 V when the received power is 10 mW. In this case, if the contactless IC card is brought closer to the reader/writer and the received power is increased to 90 mW, the power VDD is increased to 9 V. The breakdown voltage of a transistor that can be fabricated through current semiconductor process is approximately 5 V when the gate oxide film has a thickness of 10 nm. Therefore, when the power VDD is thus increased, the transistor can be broken.

In order to suppress such voltage increase of the power VDD, the shunt regulator 4 for consuming unwanted power is used. FIG. 11 is a circuit diagram of the conventional shunt regulator 4. In this shunt regulator 4, the power VDD is divided between resistors R1 and R2 to be connected to the gate of an NMOS transistor M1. The source of the transistor M1 is connected to a ground voltage VSS and the drain thereof is connected to the power VDD. In this case, the operation voltage Va of the shunt regulator 4 is determined depending upon the resistance ratio between the resistors R1 and R2 and the threshold voltage Vt of the transistor M1. When it is assumed, for example, that the threshold voltage Vt is 0.7 V, the resistor R1 has resistance of 400 kΩ and the resistor R2 has resistance of 100 kΩ, the following expression holds:

Va=(R1+R2)/R2×Vt=3.5

Therefore, the voltage increase of 3.5 V or more of the power VDD can be suppressed in this case.

In the shunt regulator shown in FIG. 11, however, the power consumption is varied in accordance with process variation and temperature change even when the power VDD remains the same. In particular, when a MOS transistor is included in the shunt regulator, the variation in the power consumption is very large. For example, if the threshold voltage Vt of the MOS transistor is varied by 0.1 V, the current flowing through the transistor and the power consumption are varied by approximately 30%. In order to suppress the DC voltage within the chip to be lower than the breakdown voltage even when the threshold voltage is thus varied, it is necessary to increase the power consumption of the shunt regulator. However, when the power consumption of the shunt regulator is increased in the wireless system employing, for example, the ASK modulation method, the signal level of an RX signal is lowered, resulting in degrading the communication quality.

FIG. 12 shows a frequency characteristic of the power consumption of the conventional shunt regulator 4 against the power VDD. Thus, the power consumption is substantially constant over the whole frequencies. Also, FIG. 13 shows a frequency characteristic of the power VDD obtained after rectifying an ASK modulation signal with the rectifier 3. The frequency characteristic can be classified into the DC, an RX signal frequency band from 100 kHz to several MHz and a carrier wave frequency band exceeding 10 MHz. The conventional shunt regulator attenuates not only a DC component but also an RX signal component.

### SUMMARY OF THE INVENTION

An object of the invention is providing a contactless IC card capable of suppressing degradation of communication quality.

According to one aspect of the invention, the contactless IC card to which power is externally supplied in a contactless manner includes a shunt regulator and a demodulation circuit. The shunt regulator attenuates, in the supplied power, a signal component in a band unwanted for demodulation of an RX signal. The demodulation circuit demodulates the RX signal from the power in which the signal component in the unwanted band has been attenuated by the regulator.

According to another aspect of the invention, the contactless IC card includes an antenna coil and a semiconductor integrated circuit. The antenna coil receives a signal from the outside in a contactless manner. The semiconductor integrated circuit includes a rectifier, a shunt regulator, a demodulator and a digital signal processor. The rectifier generates power by rectifying the signal received by the antenna coil. The shunt regulator consumes a component in a low region of the signal having been rectified by the rectifier. The demodulator extracts an RX signal from the power in which the component in the low region has been consumed by the shunt regulator. The digital signal processor receives the power obtained through rectification by the rectifier and processes the RX signal extracted by the demodulator.

Since the contactless IC card includes the shunt regulator for consuming the component in the low region of the power, degradation of communication quality can be suppressed.

According to still another aspect of the invention, the contactless IC card includes an antenna coil and a semiconductor integrated circuit. The antenna coil receives a signal from the outside in a contactless manner. The semiconductor integrated circuit includes an RX demodulator and a signal processor. The RX demodulator includes a first rectifier, a shunt regulator and a demodulator. The first rectifier generates first power by rectifying the signal received by the antenna coil. The shunt regulator consumes a component in a low region of the first power. The demodulator extracts an RX signal from the first power in which the component in the low region has been consumed by the shunt regulator. The signal processor includes a second rectifier and a digital signal processor. The second rectifier generates second power by rectifying the signal received by the antenna coil. The digital signal processor receives the second power and processes the RX signal extracted by the demodulator.

In this contactless IC card, since the RX demodulator and the signal processor are separated from each other, influence of noise generated in the digital signal processor can be reduced.

Preferably, the shunt regulator further consumes a component in a high region of the first power.

Thus, noise of a carrier wave component can be removed.

Preferably, the shunt regulator includes a low-pass filter and a transistor. The low-pass filter allows a low frequency component of the first power to pass therethrough. The transistor is connected between a power node for receiving the first power and a ground node for receiving a ground voltage and receives an output of the low-pass filter at a gate thereof.

Preferably, the shunt regulator includes a band rejection filter and a transistor. The band rejection filter allows low and high frequency components of the first power to pass therethrough. The transistor is connected between a power node for receiving the first power and a ground node for receiving a ground voltage and receives an output of the band rejection filter at a gate thereof.

Preferably, the transistor is a MOS transistor.

Preferably, a frequency of the low region is 10 kHz or less.

Preferably, a frequency of the high region is 10 MHz or more.

Preferably, the semiconductor integrated circuit further includes a TX modulator. The TX modulator modulates impedance between ends of the antenna coil in accordance with a TX signal supplied from the digital signal processor.

Preferably, the rectifier is a full-wave rectifying circuit.

Preferably, the demodulator demodulates an ASK modulation signal.

### BRIEF DESCRIPTION OF THE DRAWINGS

FIG. 1 is a block diagram for showing the structure of a contactless IC card according to Embodiment 1 of the invention;

FIG. 2 is a circuit diagram for showing the configuration of a shunt regulator shown in FIG. 1;

FIG. 3 is a diagram for showing a frequency characteristic of power consumption of the shunt regulator of FIG. 2;

FIG. 4 is a block diagram for showing the structure of a contactless IC card according to Embodiment 2 of the invention;

FIG. 5 is a circuit diagram for showing part of the configuration of a shunt regulator shown in FIG. 4;

FIG. 6 is a diagram for showing a frequency characteristic of power consumption of the shunt regulator of FIG. 4;

FIG. 7 is a circuit diagram for showing the configuration of a shunt regulator using a band rejection filter (BRF);

FIG. 8 is a block diagram for showing the structure of a contactless IC card according to Embodiment 3 of the invention;

FIG. 9 is a block diagram for showing the structure of a conventional contactless IC card;

FIG. 10 is a circuit diagram for showing the configuration of a rectifier shown in FIG. 9;

FIG. 11 is a circuit diagram for showing the configuration of a shunt regulator shown in FIG. 9;

FIG. 12 is a diagram for showing a frequency characteristic of power consumption of the shunt regulator of FIG. 9; and

FIG. 13 is a diagram for showing a frequency characteristic of power obtained after rectification.

### DETAILED DESCRIPTION OF THE INVENTION

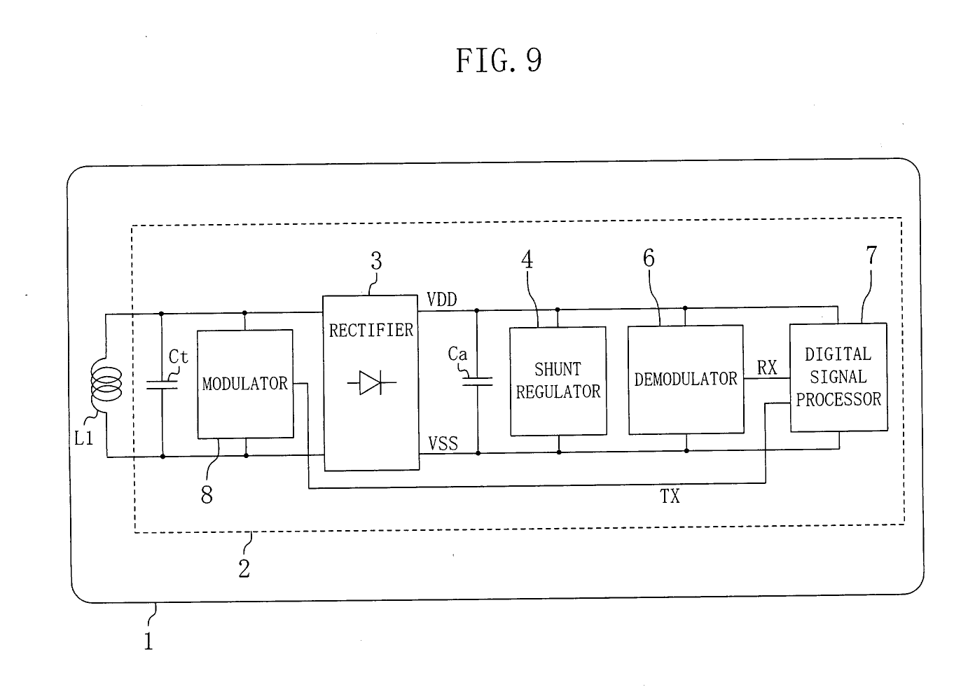

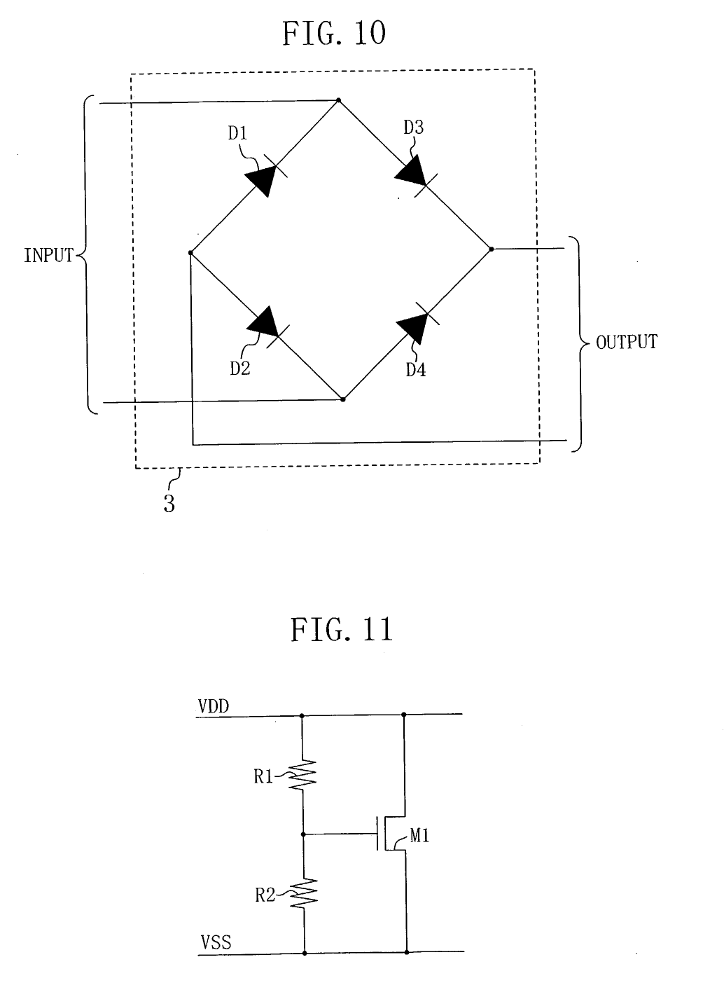

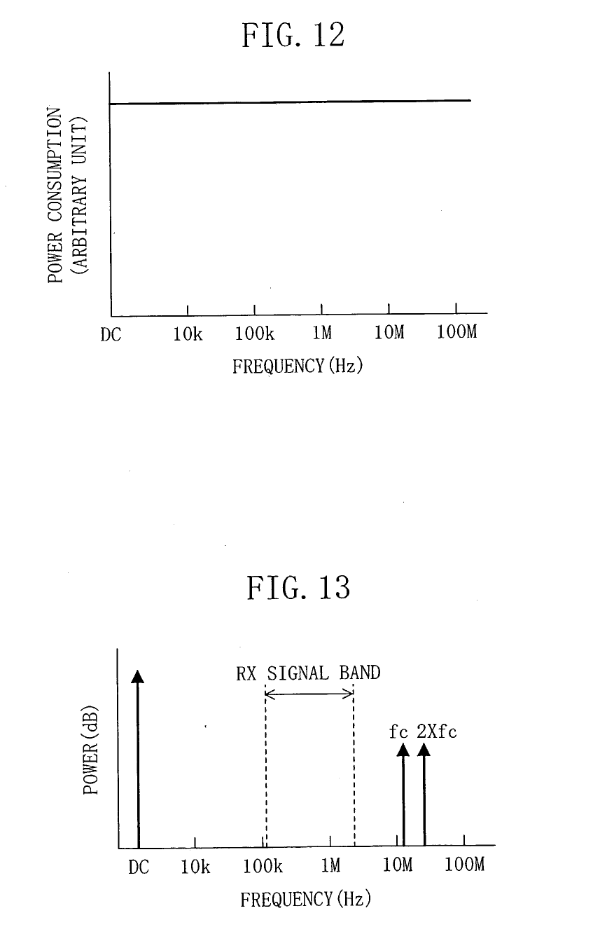

Preferred embodiments of the invention will now be described. In drawings referred to below, like reference numerals used in the conventional technique (shown in FIGS. 9 through 13) are used to refer to elements having like functions so as to omit the description.

Embodiment 1

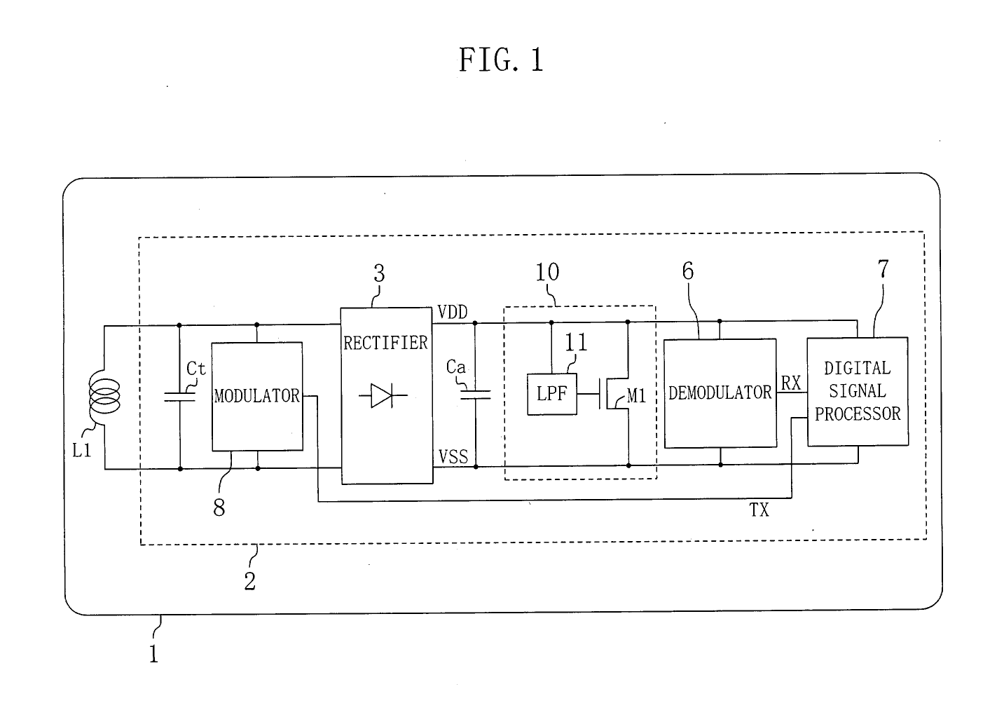

A contactless IC card according to Embodiment 1 of the invention will now be described with reference to FIG. 1.

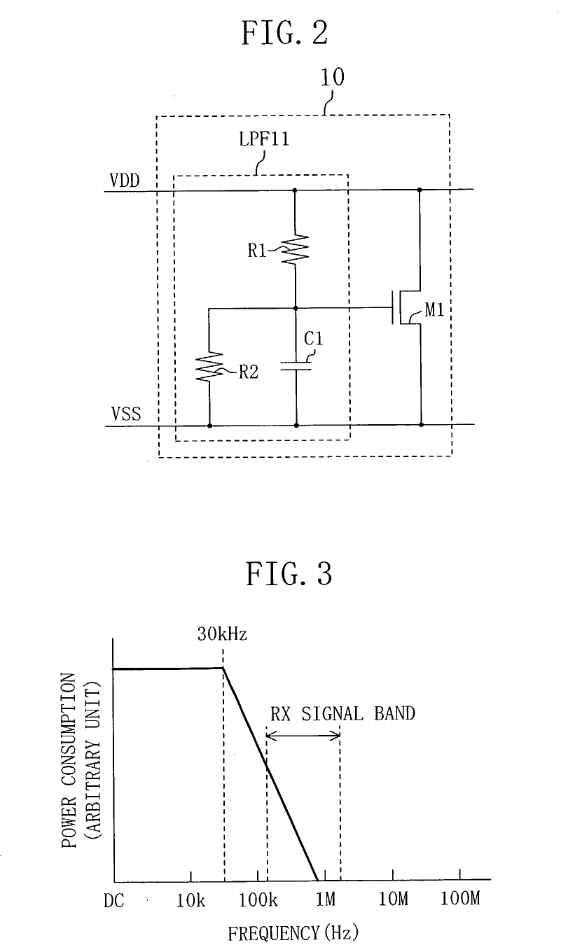

The contactless IC card of this embodiment is different from the conventional IC card (shown in FIG. 9) in including a shunt regulator 10 having a frequency characteristic against the power VDD. The shunt regulator 10 includes, as shown in FIG. 2, a low-pass filter (LPF) 11 and an nMOS transistor M1. The LPF 11 allows merely a low frequency component of the power VDD to pass therethrough. A signal having passed through the LPF 11 is supplied to the gate of the transistor M1. The drain and the source of the transistor M1 are respectively connected to the power VDD and the ground VSS. As shown in FIG. 2, the LPF 11 is herein composed of resistors R1 and R2 and a capacitor C1. When it is assumed, for example, that the resistors R1 and R2 respectively have resistance of 100 kΩ and 400 kΩ and the capacitor C1 has capacitance of 50 pF, the cutoff frequency of the LPF 11 is approximately 30 kHz. At this point, the power consumption of the shunt regulator 10 is, as shown in FIG. 3, large in a low frequency region (of 30 kHz or less) of the power VDD and is small in a high frequency region including a signal band of an RX signal (of 100 kHz through several MHz). This means that even when the power consumption of the shunt regulator 10 is increased to suppress the increase of the power VDD, the RX signal is not affected. Therefore, degradation of communication quality derived from device variation and temperature change can be suppressed, so as to realize a high performance contactless IC card.

It is noted that the modulator circuit 8, the rectifier 3, the shunt regulator 10, the RX signal frequency, the transfer rate, the carrier frequency and the modulation method employed in this embodiment are described merely as specific examples, which do not limit the invention.

For example, although a full-wave rectifying circuit is used as the rectifier 3, any circuit capable of rectifying an AC signal may be used instead.

Furthermore, although the modulator 8 is connected in parallel to the antenna coil, it may be connected between the power VDD and the ground VSS. Also, any modulator capable of modulating impedance between the ends of the antenna coil may be used. In a system where there is no need to send a signal, the modulator 8 is not necessary.

Moreover, although the shunt regulator 10 includes the MOS transistor M1, a bipolar transistor may be included instead.

Also, the modulation method may be any of the ASK modulation, PSK modulation and FSK modulation.

In short, the present invention covers all contactless IC cards each including a shunt regulator whose power consumption is large in a low frequency region of the power VDD and is small in a signal band of an RX signal.

Embodiment 2

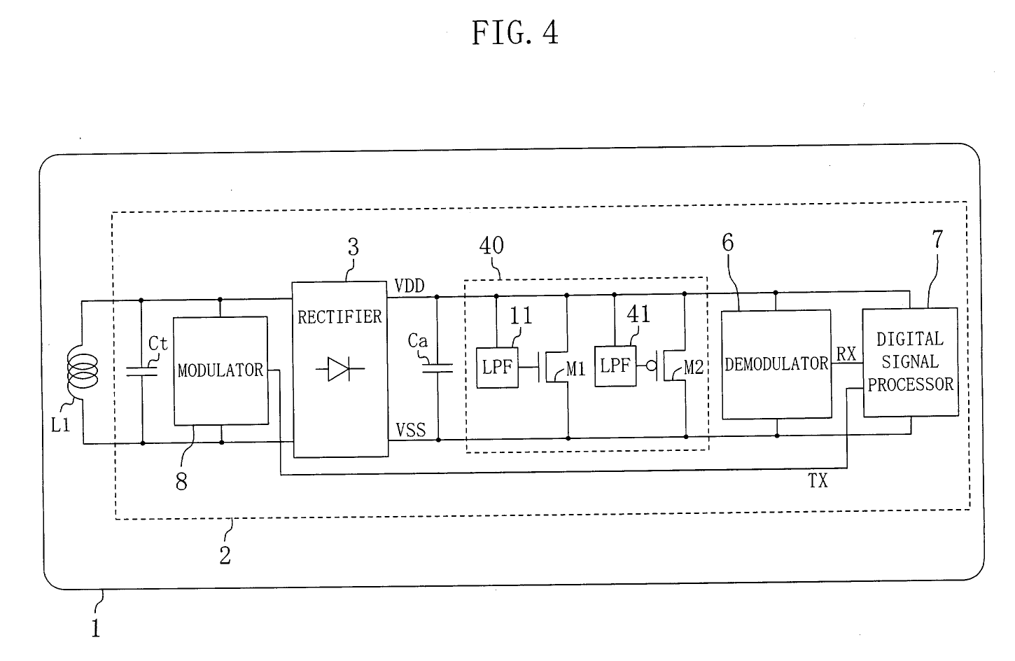

A contactless IC card according to Embodiment 2 of the invention will now be described with reference to FIG. 4.

The contactless IC card of FIG. 4 includes a shunt regulator 40 instead of the shunt regulator 10 of FIG. 1. The structure apart from the shunt regulator 40 is the same as that of the contactless IC card of FIG. 1. The contactless IC card of this embodiment is different from that of Embodiment 1 in the shunt regulator 40 further consuming power in a high frequency region of the power VDD.

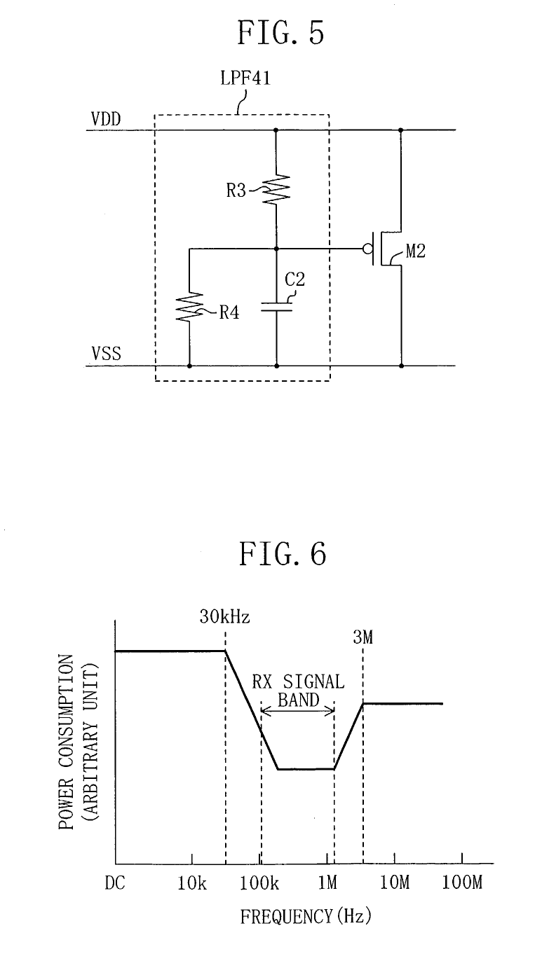

The shunt regulator 40 includes, in addition to the elements of the shunt regulator 10 of FIG. 1 (namely, the LPF 11 and the NMOS transistor M1), a LPF 41 and a pMOS transistor M2. The LPF 41 allows merely a low frequency component of the power VDD to pass therethrough. A signal having passed through the LPF 41 is supplied to the gate of the transistor M2. The source and the drain of the transistor M2 are respectively connected to the power VDD and the ground VSS. As shown in FIG. 5, the LPF 41 is herein composed of resistors R3 and R4 and a capacitor C2. When it is assumed, for example, that the resistors R3 and R4 respectively have resistance of 10 kΩ and 40 kΩ and the capacitor C2 has capacitance of 5 pF, the cutoff frequency of the LPF 41 is approximately 3 Mz. Therefore, the power consumption of the shunt regulator 40 is, as shown in FIG. 6, large in a low frequency region (of 30 kHz or less) and a high frequency region (of 3 MHz or more) of the power VDD and is small in a signal band of an RX signal (of 100 kHz through 3 MHz). Thus, the power VDD can be prevented from increasing and noise caused in a carrier signal and another frequency can be reduced. Herein, the noise caused in another frequency means noise generated in the memory, the CPU or the like of the digital signal processor 7. In this manner, the degradation of the communication quality derived from process variation and temperature change can be reduced, so as to realize a high performance contactless IC card.

The shunt regulator 40 used in this embodiment is described merely as a specific example, which does not limit the invention.

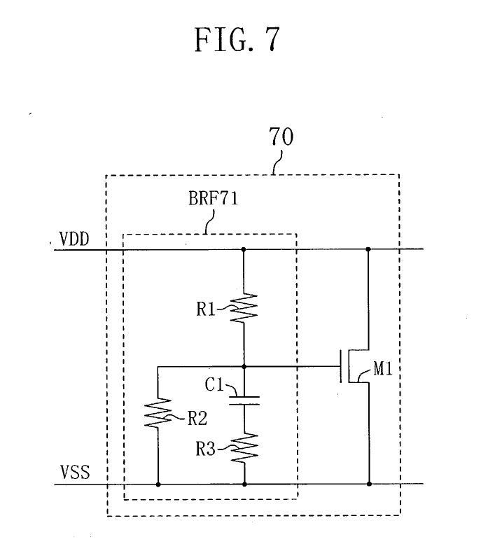

For example, the shunt regulator 40 may be replaced with a shunt regulator 70 shown in FIG. 7. The shunt regulator 70 of FIG. 7 uses a band rejection filter (BRF) 71 instead of the LPF 11 of the shunt regulator 10 of FIGS. 1 and 2. Also in such a case, the shunt regulator has a frequency characteristic as shown in FIG. 6, so that a signal component in a carrier wave band can be filtered off.

In short, the present invention covers all contactless IC cards each including a shunt regulator whose power consumption is large in low and high frequency regions of the power VDD.

Furthermore, the power consumption in the RX signal band and that in the high frequency region may be at the same level. In this case, the power consumption in the high frequency region is lowered, so as to reduce the degradation of the signal quality in the RX signal band.

Thus, the present invention is very useful for realizing a high performance contactless IC card.

Embodiment 3

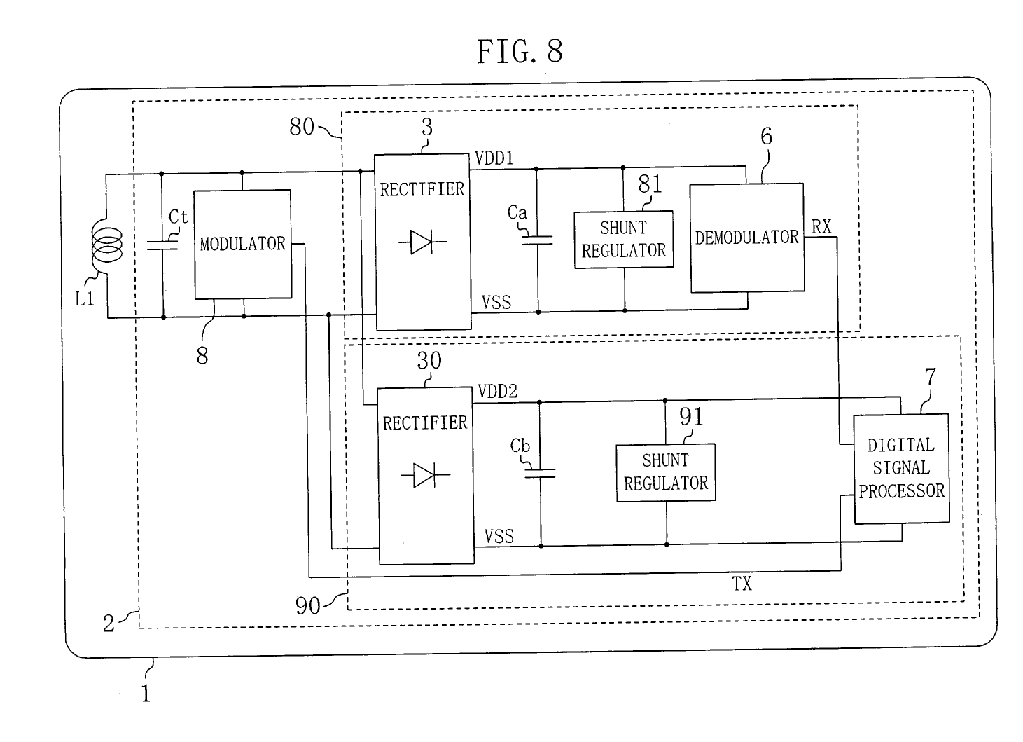

A contactless IC card according to Embodiment 3 of the invention will now be described with reference to FIG. 8.

The contactless IC card of this embodiment is different from those of Embodiments 1 and 2 in including an RX demodulator 80 and a signal processor 90 in the semiconductor integrated circuit 2.

The RX demodulator 80 includes a rectifier 3, a shunt regulator 81, a charging capacitor Ca and a demodulator 6.

The signal processor 90 includes a rectifier 30, a charging capacitor Cb, a shunt regulator 91 and a digital signal processor 7.

The inputs of the rectifier 3 and the rectifier 30 are connected to an antenna coil L1. A signal having been rectified by the rectifier 3 is supplied to the charging capacitor Ca and the shunt regulator 81, so as to generate power VDD1. The demodulator 6 extracts an RX signal from the power VDD1.

A signal having been rectified by the rectifier 30 is supplied to the charging capacitor Cb and the shunt regulator 91, so as to generate power VDD2 for the digital signal processor 7. The digital signal processor 7 processes the RX signal extracted by the demodulator 6.

As the shunt regulator 81 of this embodiment, the shunt regulator used in any of Embodiments 1 and 2 is used. As a result, a contactless IC card free from the degradation of the communication quality can be realized in the same manner as in Embodiments 1 and 2.

Furthermore, since the signal processor 90 and the RX demodulator 80 are separated from each other, the influence of digital noise generated in the digital signal processor 7 on the demodulator 6 can be further reduced.

In this manner, the present invention is very useful for realizing a high performance contactless IC card.

What is claimed is:

1. A contactless IC card to which power is externally supplied in a contactless manner, comprising:
a regulator for attenuating, in said supplied power, a signal component in a band unwanted for demodulation of an RX signal; and
a demodulation circuit for demodulating said RX signal from said power in which said signal component in said unwanted band has been attenuated by said regulator.

2. A contactless IC card comprising:
an antenna coil; and
a semiconductor integrated circuit,
wherein said semiconductor integrated circuit includes:
a rectifier for generating power by rectifying a signal received by said antenna coil;
a shunt regulator for consuming a component in a low region of said power;
a demodulator for extracting an RX signal from said power in which said component in said low region has been consumed by said shunt regulator; and
a digital signal processor for receiving said power obtained through rectification by said rectifier and processing said RX signal extracted by said demodulator.

3. The contactless IC card of claim 2,
wherein said shunt regulator further consumes a component in a high region of said power.

4. The contactless IC card of claim 2,
wherein said shunt regulator includes:
a low-pass filter for allowing a low frequency component of said power to pass therethrough; and
a transistor, connected between a power node for receiving said power and a ground node for receiving a ground voltage, for receiving an output of said low-pass filter at a gate thereof.

5. The contactless IC card of claim 3,
wherein said shunt regulator includes:
a band rejection filter for allowing low and high frequency components of said power to pass therethrough; and
a transistor, connected between a power node for receiving said power and a ground node for receiving a ground voltage, for receiving an output of said band rejection filter at a gate thereof.

6. The contactless IC card of claim 4,
wherein said transistor is a MOS transistor.

7. The contactless IC card of claim 2,
wherein a frequency of said low region is 10 kHz or less.

8. The contactless IC card of claim 3,
wherein a frequency of said high region is 10 MHz or more.

9. The contactless IC card of claim 2,
wherein said semiconductor integrated circuit further includes a TX modulator, and
said TX modulator modulates impedance between ends of said antenna coil in accordance with a TX signal supplied from said digital signal processor.

10. The contactless IC card of claim 2,
wherein said rectifier is a full-wave rectifying circuit.

11. The contactless IC card of claim 2,
wherein said demodulator demodulates an ASK modulation signal.

12. A contactless IC card comprising:
an antenna coil; and
a semiconductor integrated circuit,
wherein said semiconductor integrated circuit includes an RX demodulator and a signal processor,
said RX demodulator includes:
a first rectifier for generating first power by rectifying a signal received by said antenna coil;
a shunt regulator for consuming a component in a low region of said first power; and
a demodulator for extracting an RX signal from said first power in which said component in said low region has been consumed by said shunt regulator,
said signal processor includes:
a second rectifier for generating second power by rectifying the signal received by said antenna coil; and
a digital signal processor for receiving said second power and processing said RX signal extracted by said demodulator.

13. The contactless IC card of claim 12,
wherein said shunt regulator further consumes a component in a high region of said first power.

14. The contactless IC card of claim 12,
wherein said shunt regulator includes:
a low-pass filter for allowing a low frequency component of said first power to pass therethrough; and
a transistor, connected between a power node for receiving said first power and a ground node for receiving a ground voltage, for receiving an output of said low-pass filter at a gate thereof

15. The contactless IC card of claim 13,
wherein said shunt regulator includes:
a band rejection filter for allowing low and high frequency components of said first power to pass therethrough; and
a transistor, connected between a power node for receiving said first power and a ground node for receiving a ground voltage, for receiving an output of said band rejection filter at a gate thereof.

16. The contactless IC card of claim 14,
wherein said transistor is a MOS transistor.

17. The contactless IC card of claim 12,
wherein a frequency of said low region is 10 kHz or less.

18. The contactless IC card of claim 13,
wherein a frequency of said high region is 10 MHz or more.

19. The contactless IC card of claim 12,
wherein said semiconductor integrated circuit further includes a TX modulator, and
said TX modulator modulates impedance between ends of said antenna coil in accordance with a TX signal supplied from said digital signal processor.

20. The contactless IC card of claim 12,
wherein said rectifier is a full-wave rectifying circuit.

21. The contactless IC card of claim 12,
wherein said demodulator demodulates an ASK modulation signal.
